(19) United States
(12) Patent Application Publication
(10) Pub. No.: US 2015/0053205 A1
(43) Pub. Date: Feb. 26, 2015

(54) ILLUMINABLE AIR SUPPLY KIT

(71) Applicant: Noe Villareal, Corpus Christi, TX (US)

(72) Inventor: Noe Villareal, Corpus Christi, TX (US)

(21) Appl. No.: 14/464,672

(22) Filed: Aug. 20, 2014

Related U.S. Application Data
(60) Provisional application No. 61/868,537, filed on Aug. 21, 2013.

(51) Int. Cl. A62B 7/02; F21V 33/00; F21L 4/00; A62B 9/00; A62B 9/06

(52) U.S. Cl. CPC A62B 7/02; A62B 9/006; A62B 9/06; F21L 4/00; F21V 33/0068; F21W 2131/30
USPC 128/202.13

(57) ABSTRACT

An illuminable air supply kit for providing an emergency safety device adapted to transport and delivery for oxygen on demand. The illuminable air supply kit comprises a base canister connected to an actuating mechanism and a delivery structure connected to the actuating mechanism. The base canister is defined as a conventional canister adapted to hold pressurized air. The actuating mechanism is defined by a pressure gauge, a trigger and a dispensing structure. The delivery structure is defined by a transfer apparatus and a delivery apparatus.

### CROSS REFERENCE TO RELATED APPLICATIONS

This application claims the benefit of and incorporates by reference co-pending U.S. provisional patent application Ser. No. 61/868,537 filed Aug. 21, 2013.

### BACKGROUND OF THE INVENTION

1. Field of the Invention

This invention relates generally to safety devices and, more particularly, to a manually actuated oxygen dispensing canister surface which is visible in the dark.

2. Description of the Prior Art

The need to provide for basic safety devices to provide alerts of dangerous situations or help address or contain dangerous situations is well evident from the presence of emergency safety devices in buildings frequented by people. Indeed, the use of common emergency safety devices such as fire extinguishers, smoke detectors, and carbon monoxide detectors in dwellings and businesses is well known.

A problem which still exists, however, such common emergency safety devices do not provide for an emergency where one requires access to pure oxygen. A device which provides a source of pure, pressurized oxygen is atypical in most homes and businesses—often something only kept by individuals with known breathing problems. It is undeniable, however, that we all need oxygen and emergencies wherein a portable source of pure, pressurized oxygen is required do arise. Thus, there remains need for an air supply kit which would provide a for storage and on demand delivery of pure, pressurized oxygen. It would be helpful if such an air supply kit was portable and contained enough oxygen to allow a user to escape from dangerous and life threatening situations where the oxygen was low. It would be additionally desirable for such an air supply kit to include a surface which illuminated in the dark. It would be even further desirable for such an air supply kit to allow oxygen to be administered by non-medical personnel.

The Applicant's invention described herein provides for an illuminable air supply kit adapted to store pressurized oxygen and deliver pure oxygen from a portable container. The primary components of Applicant's illuminable air supply kit are a canister, an actuating mechanism, and a delivery structure. When in operation, the illuminable air supply kit allows a user transport and delivery pure oxygen on demand to herself or another. As a result, a limitation of prior art emergency safety devices is removed.

### SUMMARY OF THE INVENTION

An illuminable air supply kit for providing an emergency safety device adapted to transport and delivery for oxygen on demand. The illuminable air supply kit comprises a base canister connected to an actuating mechanism and a delivery structure connected to the actuating mechanism. The base canister is defined as a conventional canister adapted to hold pressurized air. The actuating mechanism is defined by a pressure gauge, a trigger and a dispensing structure. The delivery structure is defined by a transfer apparatus and a delivery apparatus.

The base canister additionally includes a fluorescent material on its surface. and a removable light compartment containing a battery powered light.

It is an object of this invention to provide an air supply kit which would provide a for storage and on demand delivery of pure, pressurized oxygen.

It is another object of this invention to provide an air supply kit which is portable and contained enough oxygen to allow a user to escape from dangerous and life threatening situations where the oxygen was low.

It is yet another object of this invention to provide an air supply kit which includes a surface which automatically illuminated in the dark.

It is still another object of this invention to provide an air supply kit which allows oxygen to be administered by non-medical personnel.

These and other objects will be apparent to one of skill in the art.

### BRIEF DESCRIPTION OF THE DRAWINGS

FIG. 1 is a front elevational view of an illuminable air supply kit built in accordance with the present invention.

FIG. 2 is a side elevational view of an illuminable air supply kit built in accordance with the present invention.

FIG. 3 is a top elevational view of an illuminable air supply kit built in accordance with the present invention.

### DETAILED DESCRIPTION OF THE INVENTION

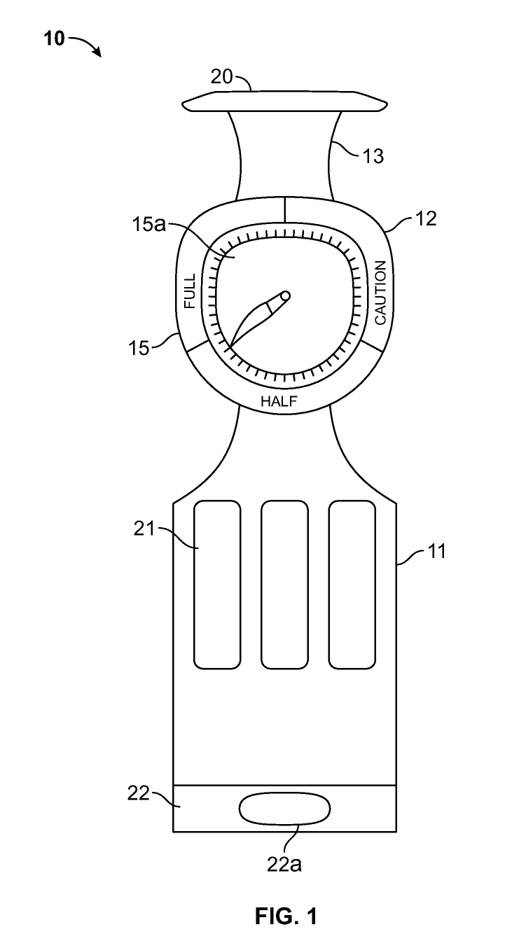

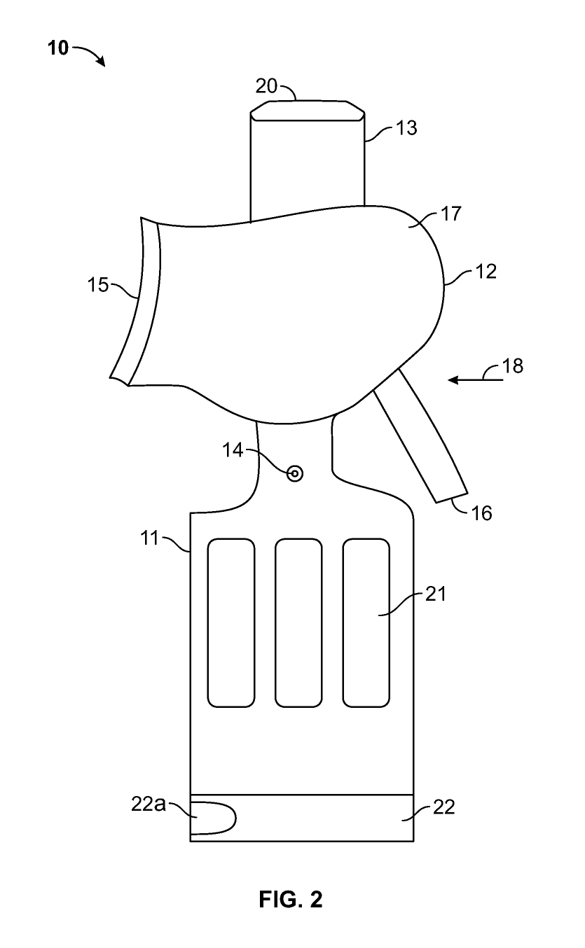

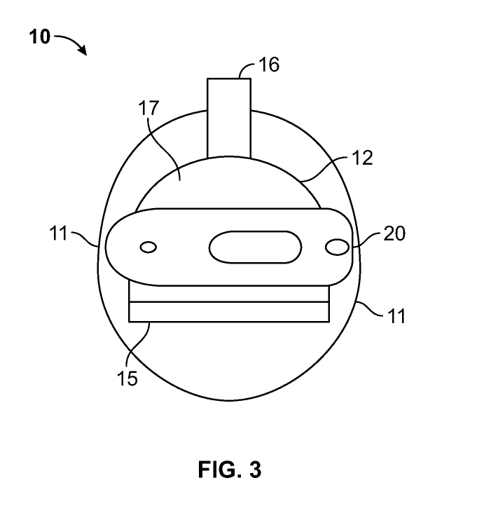

Referring now to the drawings and in particular FIGS. 1, 2, and 3, an illuminable air supply kit 10 is shown having a base canister 11 connected to one end of an actuating mechanism 12 and a delivery structure 13 connected to the other end of the actuating mechanism 12. In the preferred embodiment, the illuminable air supply kit 10 measures approximately ten inches in height and two inches in diameter. The base canister 11 is defined as a conventional canister adapted to hold pressurized air. It includes an intake value 14 which is adapted to allow pressurized oxygen to be introduced to the base canister 11.

The actuating mechanism 12 is defined by a pressure gauge 15, a trigger 16 and a dispensing structure 17. The pressure gauge 15 is adapted to track the air pressure in the base canister 11 at all times and display information relating to the air pressure on a visual interface 15a. The visual interface 15a allows a user to track the amount of oxygen in the base canister 11 by way of the air pressure measurement, which is adapted on the visual interface 15a to correlate to the status concepts of FULL, HALF, and CAUTION. In the preferred embodiment, FULL indicates the base canister 11 is substantially full or is no less than two thirds of its capacity, HALF indicates the base canister 11 is approximately half full or between two thirds and one thirds of its capacity, and CAUTION indicates the base canister 11 is nearly empty or has less than one thirds of its capacity remaining. In an alternate embodiment, the visual interface 15a includes measurements of time which allow a user to ascertain how much oxygen remains in the base canister 11 measured by how much approximate use time is possible at a given moment.

The trigger 16 and the dispensing structure 17 work in concert to allow oxygen in the base canister 11 to be delivered to the delivery structure 13 to be dispensed. When manual force is exerted on the trigger in an engaging direction 18, oxygen in the base canister 11 exits the base canister 11 in a controlled manner, is substantially depressurized, and is delivered to the delivery structure 13.

The delivery structure 13 is defined by a transfer apparatus and a delivery apparatus 20. The transfer apparatus is a conduit disposed on top of the dispensing structure 17 which is configured to receive depressurized oxygen and direct it to the delivery apparatus 20. The delivery apparatus 20 is defined as a conventional mouthpiece designed to a user to place her mouth around it and allow air to be inhaled through its body in the preferred embodiment. It is understood that any type of structure which facilitates direct delivery of air into a user's mouth may be utilized as a delivery apparatus 20. Thus, in an alternate embodiment, the delivery apparatus 20 is defined as a hose. In another alternate embodiment, the delivery apparatus 20 is defined as a facemask.

The base canister 11 additionally includes fluorescent material on its side surfaces. The fluorescent material, defined as a plurality of strips 21 which encircle the body of the base canister 11 in the preferred embodiment, allows for the illuminable air supply kit 10 to be plainly visible in the dark.

The base canister 11 also includes in the preferred embodiment a light compartment 22 containing a battery powered light 22a removably attached to its bottom surface. The removable light compartment is a self contained light source and allows the illuminable air supply kit 10 to project light to assist a user in finding her way out of a dark environment.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An illuminable air supply kit, comprising:
a base canister defined as a conventional canister adapted to hold pressurized air, wherein the base canister includes at least one of fluorescent material defined as a plurality of strips disposed on its exterior side surfaces and a light compartment containing a battery powered light removably attached to its bottom surface;
a delivery structure that includes a delivery apparatus, wherein said delivery structure is configured to receive depressurized oxygen and the delivery apparatus is configured to direct depressurized oxygen into the user's mouth; and
an actuating mechanism that includes by a trigger and is connected to one end to the base canister and the other end to the delivery structure, wherein said actuating mechanism is adapted to cause oxygen in the base canister to depressurize and move into the delivery structure;

2. The illuminable air supply kit of claim 1, wherein the base canister additionally includes an intake value adapted to allow pressurized oxygen to be introduced to the base canister.

3. The illuminable air supply kit of claim 1, wherein the base canister includes fluorescent material defined as a plurality of strips disposed on its exterior side surfaces and a light compartment containing a battery powered light removably attached to its bottom surface

4. The illuminable air supply kit of claim 1, wherein the actuating mechanism additionally includes a pressure gauge adapted to measure and display the air pressure in the base canister.

5. The illuminable air supply kit of claim 1, wherein the delivery apparatus is defined as a conventional mouthpiece configured to allow a user to place her mouth entirely around it so that all of the depressurized oxygen is delivered into the user's mouth.
